(19) United States
(12) Patent Application Publication
(10) Pub. No.: US 2012/0261629 A1
(43) Pub. Date: Oct. 18, 2012

(54) VERTICAL LIFT MECHANISM FOR USE IN CONFINED SPACES

(76) Inventor: Eric Andkjar, Callicoon, NY (US)

(21) Appl. No.: 13/448,484

(22) Filed: Apr. 17, 2012

Related U.S. Application Data
(60) Provisional application No. 61/517,328, filed on Apr. 18, 2011.

(51) Int. Cl. B66D 1/02

(52) U.S. Cl. 254/264

(57) ABSTRACT

A compact lift apparatus for use in confined spaces to raise and lower an object is described. The apparatus includes first and second drag chains with upper object mourning ends that are moveable along paths having adjacent vertical inner sections with lower ends and chain storage sections extending outwardly from the lower ends of the lower sections, the chain storage sections extending outwardly in opposite directions; spaced parallel plates on opposite sides of the chains, the plates including inner faces that together define drag chain raceways forming the paths; and drive means simultaneously conveying the drag chains along the paths between the lowered and raised positions to raise and lower the mounting ends, the drive means including first and second rotatable sprockets having teeth engaging the chain lengths and a drive means to rotate at least one of the sprockets.

This application claims the benefit of the filing date of U.S. Provisional Application Ser. No. 61/517,328, filed Apr. 18, 2011, which is incorporated herein in its entirety.

### BACKGROUND OF THE INVENTION

(1) Field of the Invention

The present invention relates generally to a mechanism for raising and lowering an object, and in particular to a vertical lift mechanism having a lowered height significantly less than the distance the object is lifted.

(2) Description of the Prior Art

Lightweight devices, such as still and video cameras, electronic monitors, televisions, etc., are often supported on mechanisms to raise the devices for use and then lower the device for storage. For example, the device may be attached to the upper end of a motorized or hydraulic multi-section telescoping pole. In other instances, the device can be attached to the distal end of a pivotal arm that is moveable between a horizontal lowered position and a vertical raised position.

These and other mechanisms have limited utility, however, where there is limited space available for housing the lift mechanism. For example, the device may be stored in a recess in the top of a desk, table or cabinet where there is limited space beneath the device for a lift mechanism. In such arrangements, lifting of the device to the extent desired may not be possible with conventional lift mechanisms.

### SUMMARY OF THE INVENTION

The present invention relates to a lift mechanism utilizing drag chains that can be housed in a space having a small vertical dimension relative to the distance the mechanism can lift a supported device. Drag chains, also known as wire management chains, cable carriers, energy chains, or cable chains, depending on the manufacturer, are commonly used to surround and guide flexible cables, hoses and wiring in moving machinery, mounting brackets, etc.

Basically, a drag chain, the term being used to encompass all of the above terms, is comprised of a plurality of attached box-like links having parallel sides and transverse upper and lower cross bars. The links are joined to permit bending in one plane and in one direction. The chain links are usually formed of polypropylene or other durable plastic. The term “drag chain” is used herein to define a chain having these structural features and not necessarily to require a chain in which a hose, cable or wiring is inserted through the interior of the chain.

In the present invention, two chain sections cooperate to support a device or mount for a device at their distal ends, with means being provided to raise and lower the distal ends of the chains. More specifically, the present mechanism is comprised of first and second opposed drag chains having their inner distal ends extending vertically upward, with the ends being attached to each other.

The chains extend vertically downward from their distal ends, curving toward their outer ends, which extend horizontally in opposite directions, and optional into a coiled configuration. The mechanism also includes a chain guide having opposed downwardly and outwardly curved faces against which the lower surfaces of the chains ride, or a chain raceway.

The apparatus also includes a drive means for conveying the chains along paths. For example, a pair of sprockets may ride against the upper surfaces of the chains opposite the curved faces of the guides, with the sprocket teeth meshing with the upper bars of the chain links. A drive means such as an electric motor is linked directly or indirectly to the sprockets to rotate the sprockets. Both sprockets may be driven by the drive means. However, since the chains are attached at their distal ends, only one of the sprockets needs to be a driven sprocket, while the other sprocket can be an idler sprocket.

In order to ensure accurate alignment and synchronization of the drag chains, the links of one of the drag chains may be releasably attached to the adjacent links of the other chain within the vertical section of the chain path. Thus, the latching member, e.g., a male latching member, on a link in one chain joins another latching member, e.g., a female latching member, on a link in the other chain, are raised and the links are conveyed from the chain storage section to the vertical section. The chain links are then separated as the chains are lowered.

The exact configuration of the latching members can vary considerably so long as the members contribute to holding the chains together. For example, one chain can have a hole with a link of the opposed inner link having a projection that is inserted into hole. The holes and projections can alternate from link to link. It will be understood that other latching means may be employed to hold the chains in alignment. For example, the projections can be in the form of hooks that insert into the holes of loops on opposed links.

In operation, with the lift mechanism in its fully lowered position, and the device to be lifted is attached to the joined distal ends of the drag chains, the drive means is actuated to rotate at least one of the drive sprockets with the sprockets rotating in opposite directions. Rotation of at least one of the sprockets in turn moves the chains in an upward direction to vertically lift the supported device. The sprockets are rotated in the opposite direction to lower the device.

In the fully lowered position, only a small section of the chains need to be in the vertical or curved orientation, while most of the chain lengths are in a horizontal or coiled orientation. As a result, the vertical space required to house the lift mechanism can be very small relative to the vertical height to which the device can be raised by the mechanism.

In an embodiment of the invention, the compact lift apparatus for use in confined spaces to raise and lower an object is comprised of first and second drag chains that have upper object mounting ends, e.g., ends to mount an electronic device. The chains have fully lowered and fully raised positions, and are moveable along paths having vertical inner sections with lower ends and chain storage sections extending outwardly from the lower ends of said lower sections.

The path vertical inner sections are parallel and adjacent, while the chain storage sections extend outwardly in opposite directions. The chain storage sections may be horizontal, or coiled for greater storage capacity. For example, the storage sections may curve outwardly from the lower ends of the vertical sections along initial horizontal path sections, and then curve upwardly to coiled sections.

The paths may be defined by spaced parallel plates on opposite sides of the chains, with the plates including inner faces having drag chain raceways. For example, the plate inner faces may include recesses that together define chain raceways. Each recess includes side walls and a bottom wall, with the distance between the bottom walls of the facing recesses being approximately equal to the width of the chains.

Drive means comprised of first and second sprockets engage the chains to simultaneously convey the drag chains along the paths between the lowered and raised positions to raise and lower the mounting ends and any object carried thereon. The sprockets are preferably simultaneously rotatable in opposite directions, and are preferably located at the inner curvature of the paths where the path inner sections join the path chain storage sections. One or both of the sprockets can be driven, with the other sprocket being an idler sprocket.

An apparatus of the present configuration enables raising and lowering of an object, e.g., an electronic device, to heights substantially greater than the vertical height of the space required to store the chains. For example, the distance between the lowered and raised heights of the mounting ends can be at least 2 to 6 times the vertical height of the chain storage space. Stated another way, the chains can have lengths at least 2 to 6 times the length of the path vertical sections.

### BRIEF DESCRIPTION OF THE DRAWINGS

FIG. 1 is a perspective view of the lift mechanism in its fully lowered position.

FIG. 2 is a side view of the lift mechanism in its fully lowered position.

FIG. 3 is a side view of a section of drag chain.

FIG. 4 is a top view of a section of drag chain.

FIG. 5 is a perspective view of the lift mechanism in its fully raised position.

FIG. 6 is a side view of the lift mechanism in its fully raised position.

FIG. 7 is a view of the facing surfaces of links in opposed drag chains showing connectors.

FIG. 8 is a plan view of the inner face of a first housing plate with the drag chains within raceway sections.

FIG. 9 is a plan view of the inner face of a second housing plate, which is a mirror image of the first housing plate, with the drag chains within raceway sections.

FIG. 10 is an end view of the lift apparatus showing the spaced housing plates and drag chain.

### DETAILED DESCRIPTION OF THE INVENTION

In the following description, terms such as horizontal, upright, vertical, above, below, beneath, and the like, are used solely for the purpose of clarity in illustrating the invention, and should not be taken as words of limitation. The drawings are for the purpose of illustrating the invention and are not intended to be to scale.

As seen in the drawings, a preferred embodiment of the lift mechanism, generally 10, is comprised of drag chains 12 and 14 joined at the lower surfaces of their inner ends, a guide 16, sprockets 20 and 22, and drive means 24, such as an electric motor.

As illustrated in FIGS. 3 and 4, each of drag chains 12 and 14 are comprised of a plurality of attached links, generally 30 having side plates 32 and 34, and upper transverse bars 36, which serve to engage the teeth of sprockets 20 and 22, and lower transverse bars 38.

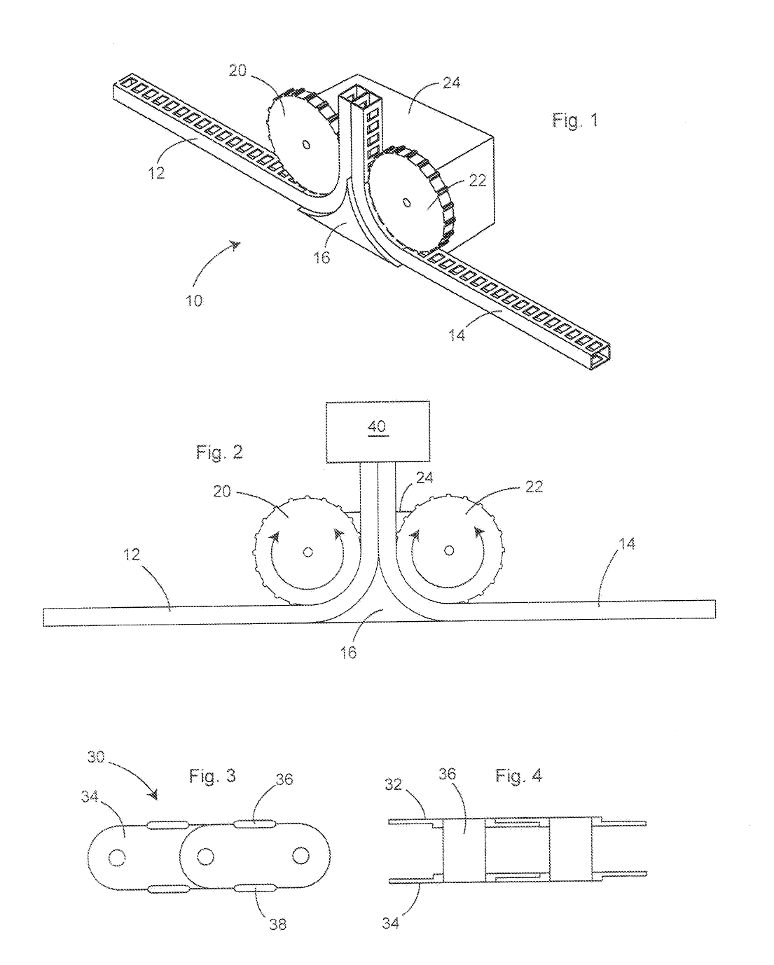

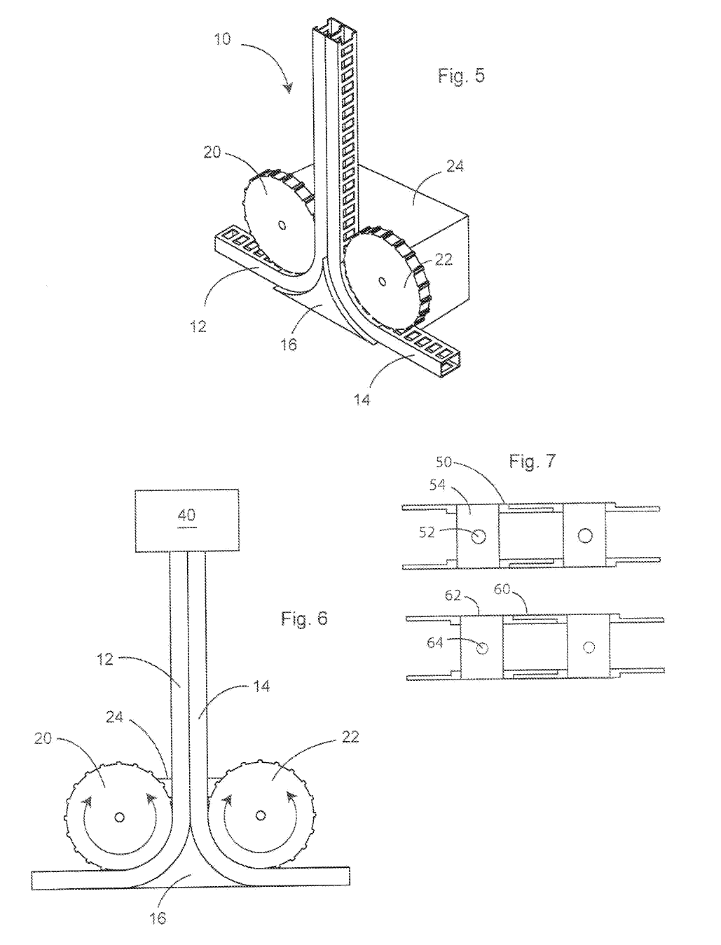

Drag chains 12 and 14 are mirror images, each having a vertical inner section, a horizontal outer section, and an intermediate curved section joining the inner and outer sections. Rotation of drive means 24 rotates sprockets 20 and 22 in opposite directions to raise or lower the inner end of lift mechanism 10, and device 40, supported thereon. One or both sprockets 20 and 22 may be driven. As will be observed in comparing the lowered position of FIGS. 1 and 2 against the raised position in FIGS. 5 and 6, it will be seen that the height to which the electronic device 40 can be raised is substantially greater than the height of the lift mechanism in its lowered position.

In order to ensure accurate alignment and synchronization of drag chains 12 and 14, the links of one of the drag chains may include projections that are insertable into recesses in a link of the opposed chain. For example, FIG. 7 illustrates link 50 of one chain having holes 52 in inner transverse bar 54, with link 60 of the opposed inner transverse bar 62 having projections 64 that are inserted into holes 52 as the bars are brought into contact. It will be understood that other latching means may be employed to hold the chains in alignment. For example, the holes and projections on the bars can alternate.

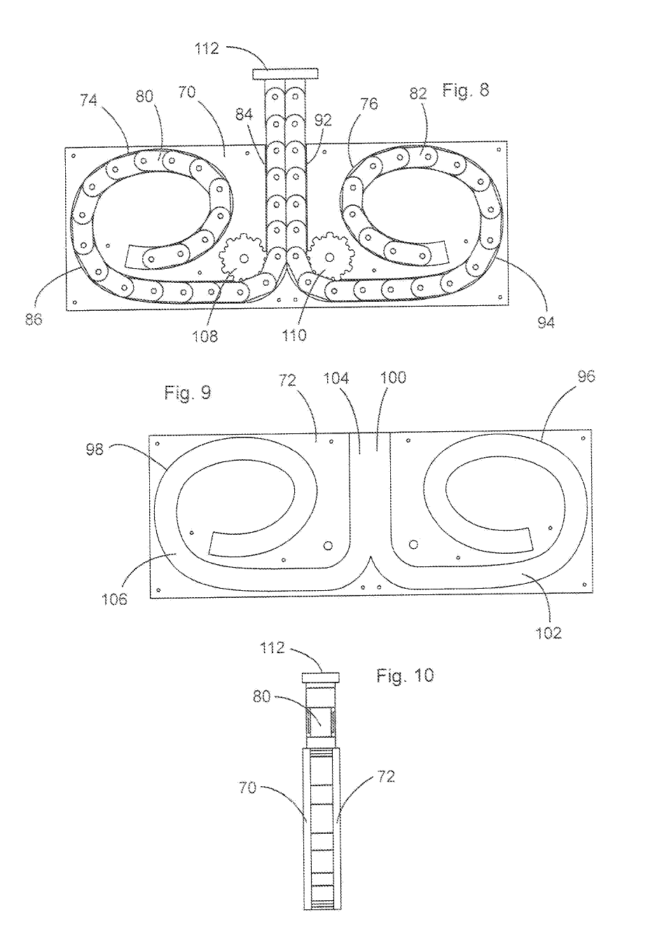

FIGS. 8 and 9 illustrate the apparatus of the invention with housing plates 70 and 72. Plate 70 is illustrated in detail in FIG. 8. Plate 72 is a mirror image of plate 70. Plate 70 includes recesses 74 and 76 to receive chains 80 and 82, respectively. Recess 74 includes inner vertical section 84 and outer coiled chain storage section 86, while recess 76 includes inner vertical section 92 and outer coiled chain storage section 94.

Plate 72 is illustrated in detail in FIG. 9. Plate 72 is a mirror image of plate 70. Plate 72 includes recesses 96 and 98 to receive chains 80 and 82, respectively. Recess 96 includes inner vertical section 100 and outer coiled chain storage section 102, while recess 98 includes inner vertical section 104 and outer coiled chain storage section 106. Recesses 74 and 76 and facing recesses 96 and 98 in plate 72 form raceways to guide chains 80 and 82. Sprockets 108 and 110, shown in FIG. 8, are rotatable in opposite directions to convey chains 80 and 82 along the raceways formed by the facing recesses. Mounting plate 112 is attached to the distal ends of chains 80 and 82.

Certain modifications and improvements will occur to those skilled in the art upon a reading of the foregoing description. It should be understood that all such modifications and improvements have been deleted herein for the sake of conciseness and readability but are properly within the scope of the following claims.

What is claimed is:

1. A compact lift apparatus for use in confined spaces to raise and lover an object comprising:
a) first and second drag chains with upper object mounting ends having fully lowered and fully raised positions, said chains being moveable along paths having vertical inner sections with lower ends and chain storage sections extending outwardly from the lower ends of said lower sections, said inner sections being adjacent each other and said chain storage sections extending outwardly in opposite directions; and
b) drive means to simultaneously convey said drag chains along said paths between said lowered and raised positions to raise and lower said mounting ends.

2. The apparatus of claim 1, wherein said drive means includes at least one rotatable drive sprocket having teeth engaging one of said chains and at least one motor to rotate said sprocket.

3. The apparatus of claim 1, further including latching means to secure said chains together along said vertical inner sections.

4. The apparatus of claim 1, wherein said chain storage sections are horizontal.

5. The apparatus of claim 1, wherein said chain storage sections are coiled.

6. The apparatus of claim 1, further including at least one guide directing said chains along said paths.

7. The apparatus of claim 1, further including spaced parallel plates on opposite sides of said chains, said plates including inner faces with mirror image recesses together forming drag chain raceways defining said paths.

8. The apparatus of claim 1, wherein said chains have lengths at least 2 to 6 times the lengths of said path vertical sections.

9. A compact lift apparatus for use in confined spaces to raise and lower an object comprising:
a) first and second drag chains with upper object mounting ends having fully lowered and fully raised positions, said chains being moveable along paths having vertical inner sections with lower ends and chain storage sections extending outwardly from the lower ends of said lower sections, said inner sections being adjacent each other and said chain storage sections extending outwardly in opposite directions;
b) spaced parallel plates on opposite sides of said chains, said plates including inner faces with recesses defining drag chain raceways forming said paths; and
c) drive means to simultaneously convey said drag chains along said paths between said lowered and raised positions to raise and lower said mounting ends.

10. The apparatus of claim 9, wherein said drive means includes at least one rotatable sprocket having teeth engaging one of said chains and at least one motor to rotate said sprocket.

11. The apparatus of claim 9, further including latching means to secure said chains together along said vertical inner sections.

12. The apparatus of claim 9, wherein said chain storage sections are horizontal.

13. The apparatus of claim 9, wherein said chain storage sections are coiled.

14. The apparatus of claim 9, wherein said chains include links having parallel side plates joined by transverse bars, said chains being pivotal in the vertical plane, but not in the horizontal plane.

15. The apparatus of claim 9, wherein said chains have lengths at least 2 to 6 times the lengths of said path vertical sections.

16. The apparatus of claim 9, wherein the chains have fully extended vertical lengths at least 2 to 6 times the vertical heights of said chain storage sections.

17. A compact lift apparatus for use in confined spaces to raise and lower an object comprising:
a) first and second drag chains with upper object mounting ends having fully lowered and fully raised positions, said chains being moveable along paths having vertical inner sections with lower ends and chain storage sections extending outwardly from the lower ends of said lower sections, said inner sections being adjacent each other and said chain storage sections extending outwardly in opposite directions, said drag chains including a plurality of connected links pivotal in the vertical plane, but not in the horizontal plane;
b) spaced parallel plates on opposite sides of said chains, said plates including inner faces with mirror image recesses defining drag chain raceways forming said paths; and
c) drive means to simultaneously convey said drag chains along said paths between said lowered and raised positions to raise and lower said mounting ends, said drive means including first and second rotatable sprockets having teeth engaging said chain lengths and at least one motor to rotate said sprockets in opposite directions.

18. The apparatus of claim 17, wherein said chain links include transverse bars engaged by said sprocket teeth.

19. The apparatus of claim 17, wherein said chain links include mating latching members joining said chain links within said vertical inner path sections.

20. The apparatus of claim 17, wherein said locking members include a recess in a chain link in one of said chains and a pin on a link in a chain link in the other of said chains, said pin being insertable into said recess when said chain links are adjacent each other within said vertical section.
